(19) United States
(12) Patent Application Publication
(10) Pub. No.: US 2013/0204692 A1
(43) Pub. Date: Aug. 8, 2013

(54) ARTISTIC AUDITIONS USING ONLINE SOCIAL NETWORKING

(71) Applicants: Troy Christopher Mallory, Burbank, CA (US); Andrew Iborg Levy, Pasadena, CA (US)

(72) Inventors: Troy Christopher Mallory, Burbank, CA (US); Andrew Iborg Levy, Pasadena, CA (US)

(21) Appl. No.: 13/365,985

(22) Filed: Feb. 3, 2012

(51) Int. Cl. G06F 3/01; G06Q 30/02

(52) U.S. Cl. 705/14.36; 715/753; 705/14.66

(57) ABSTRACT

A method and a system are disclosed including an audition website configured to allow a user to register and upload an artistic performance piece associated with the user, such as a music or a video clip, via a computer network to an online performance venue for audition, viewing, ranking, competition, and other actions by other participants and commercial entities. In various embodiments, the user registers at the audition website, creates a user profile within a first predetermined time period, and uploads an artistic multimedia performance file to the audition website within a second predetermined time period, to gain recognition, to have the performance reviewed and rated by peers and others, to view statistical data about audition candidates, and to otherwise interact with others associated with the audition website.

### TECHNICAL FIELD

This application relates generally to artistic audition processes. More specifically, this application relates to artistic auditions using online social networking websites.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1; and

FIG. 3 shows an example artistic audition webpage configured for user registration;

FIG. 4 shows an example artistic audition webpage configured for user profile building; and

FIG. 5 shows an example artistic audition webpage configured for audition submission.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references music auditions, it will be appreciated that the disclosure may be used with other types of candidate auditions, such as theatrical and performing arts auditions, public office elections, and the like.

Briefly described, in some embodiments, a device and a method are disclosed including an audition website configured to allow a user to register and upload an artistic performance piece associated with the user, such as a music or a video clip, via a computer network to an online performance venue for audition, viewing, ranking, competition, and other actions by other participants and commercial entities. In various embodiments, the user registers at the audition website, creates a user profile within a first predetermined time period, and uploads an artistic multimedia performance file to the audition website within a second predetermined time period, to gain recognition, to have the performance reviewed and rated by peers and others, to view statistical data about audition candidates, and to otherwise interact with others associated with the audition website.

With the ubiquity of users' internet access, highly integrated devices, such as new powerful personal computers, smartphones, and other similar computing devices having high resolution cameras and microphones capable of taking pictures and videos, record high quality sounds, and also the proliferation of online social networks, such as Facebook™, there is an ever increasing opportunity for presentation of artistic performances, by amateur and professional artists alike, to a wider audience for the purpose of recognition, evaluation and rating, commercial gain, or similar activities. Accordingly, demand by artists, spectators, talent scouts, and the like for high quality sharing of personal and professional profiles and work products is increasing. For example, Youtube™ is often used to post personal performance videos about almost any subject including artistic performances. However, the common methods used to take and post video and sound online, such as using a common video camera and posting a video clip, is generally not organized, can be cumbersome, time consuming, and limited in their capabilities such as efficient, purposeful, and organized interactions with others.

### Illustrative Operating Environment

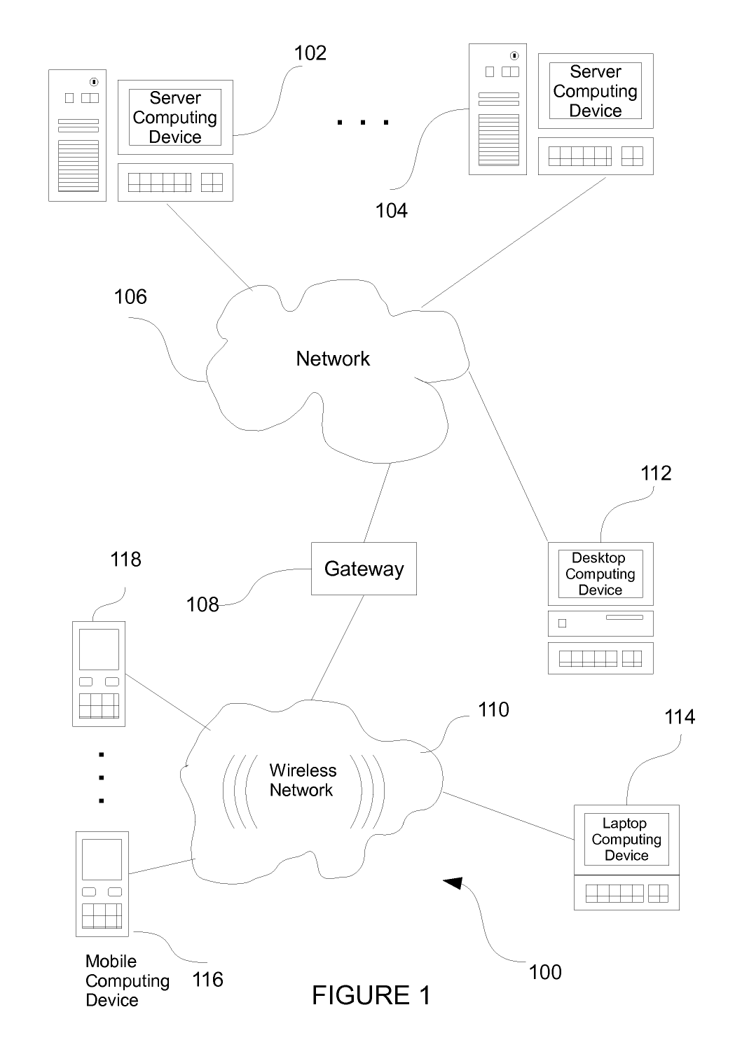

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

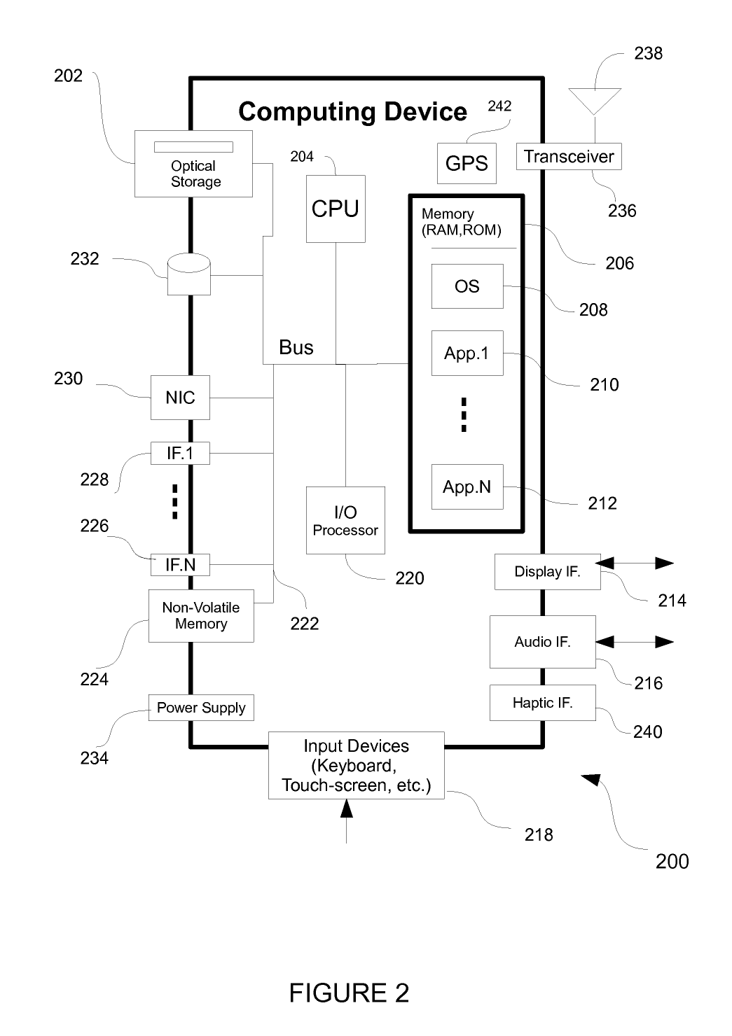

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, digital cameras, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, and the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like.

In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G), generation and any future generation technologies for radio access for cellular systems, WLAN, Wireless Router (WR) mesh, and the like. Access technologies such as 3G, 4G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), HDMI (High Definition Multimedia Interface), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

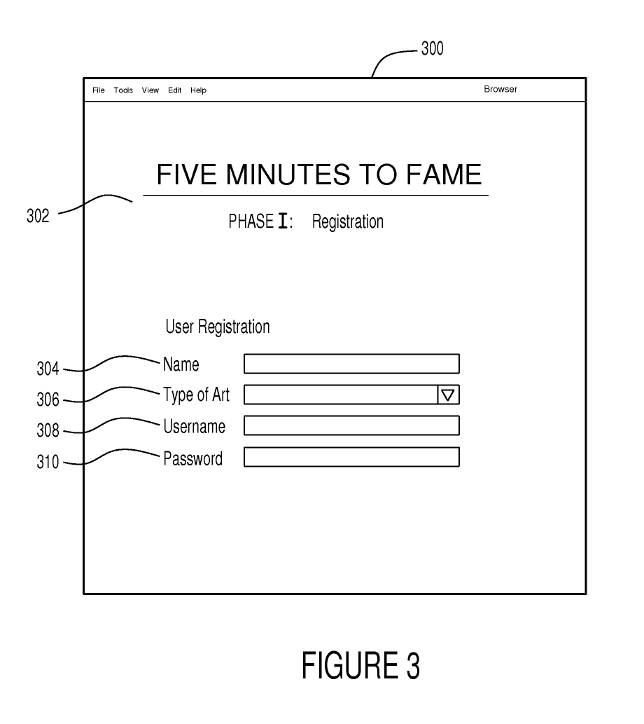

FIG. 3 shows an example artistic audition webpage configured for user registration. In various embodiments, an audition website, provided by a server similar to those described with respect to FIG. 1 above, may include registration webpage 300 used to present information usable to register a user and open a new user account for later audition activities, webpage 300 including title 302, name field 304, type of art field 306, and new account information such as username 308 and password 310.

In various embodiments, the overall audition process may be divided into several distinct phases. For example, phase I may be used for registration, phase II may be used for user profile creation/update, and phase III may be used for submitting audition material. Those skilled in the art will appreciate that the overall audition process may be divided into fewer or more phases without departing from the spirit of the present disclosure.

In some embodiments, during phase I of the overall audition process, user registration may be effected by purchasing a card from a point of sale, which includes a unique user ID usable to allow the card holder to login to an audition website, using a computing device similar to those described above with respect to FIG. 2, to submit his audition material. The unique user ID may be an alternative to username 308 and password 310 credentials. In other embodiments, both unique user ID and username/password may be required and/or used for account access. In still other embodiments, the unique user ID is used to access the website, and then register and create a new user account with a new username and password. In some embodiments, the user may have multiple accounts while in other embodiments, the user may be limited to a single account.

In various embodiments, the registration is a one-time registration for a permanent account useable to login multiple times and submit multiple audition submissions over time, while in other embodiments, the registration and/or account are for a single submission only. In the latter embodiment, to participate in another audition or contest, the user may have to register again and obtain a new account for further participation. Once a particular audition for a particular user is over and results of the audition, such as ranking and establishing contact with a talent scout, are returned to the user, the user account may be terminated. In still another embodiment, a new account may have a predetermined number of auditions associated with it before termination. For example, depending on how much a user pays, he may get an account with five or 10 auditions after which the account terminates.

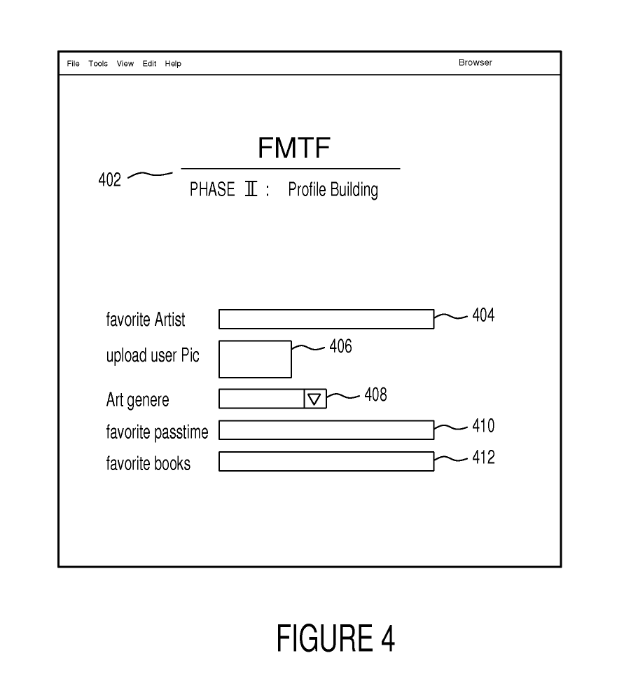

FIG. 4 shows an example artistic audition webpage configured for user profile building. In various embodiments, the audition website may include a profile building webpage having title 402, and profile questions such as favorite artist 404, art genre 408, favorite pass-time 410, and favorite book 412. The profile building webpage may further include user picture upload button 406 usable to upload a picture of the user opening a new account.

In various embodiments, the user may be able to update his profile and/or change his picture, password, and the like, in phase II of the process. In some embodiments, the user may be able to create an avatar to represent himself as an animated persona.

In various embodiments, the user's profile may be used to present tailored and/or targeted advertisements to the user when he logs in to the audition website. Such advertisements may belong to third party commercial entities, such as musical instrument makers/sellers, or may belong to other service providers such as voice trainers and music teachers. In some embodiments, the user profile may be used by audition website provider to group users with similar profiles together and send them messages of common interest, invite them to competition or collaboration on a project, offer them services, and the like.

In various embodiments, the overall process of audition is kept within certain time limits to allow quick access to an audition forum by the user. Traditional auditions can be cumbersome, expensive, and time consuming because they often involve creating an elaborate professional profile, having an agent, contacting talent agencies, arranging meetings, and other similar activities, which may or may not result in favorable audition sessions. Therefore, keeping the overall process time limited can be very attractive to auditionees because they are able to get to the audition quickly and multiple times. In some embodiments, there is one time limit for the whole process, while in other embodiments, each phase of the audition process may have its own corresponding time limit. For example, a predetermined profile time may be allowed for creating a user profile by answering a few questions. In some embodiments, the predetermined profile time may be a few minutes, for example, three minutes. In some embodiments, the time limit for each phase may be dynamically determined and adjusted based on entered user profile, music genre, or other criteria. For example, as the user enters his profile data, the audition website may determine to extend the time for the current phase by an appropriate amount.

In some embodiments, the predetermined profile time is measured, tracked, and displayed to the user to keep the process fast and streamlined. In various embodiments, if the user cannot complete a timed process phase or step within the predetermined time limits, he may be locked out for a period of time, for example 24 hours, before he is allowed to try again. This encourages a candidate for audition to organize his information before attempting to register. In other embodiments, the user may be rewarded, for example, by giving award points redeemable for some benefits or services later, if he can finish the step within the allotted time period.

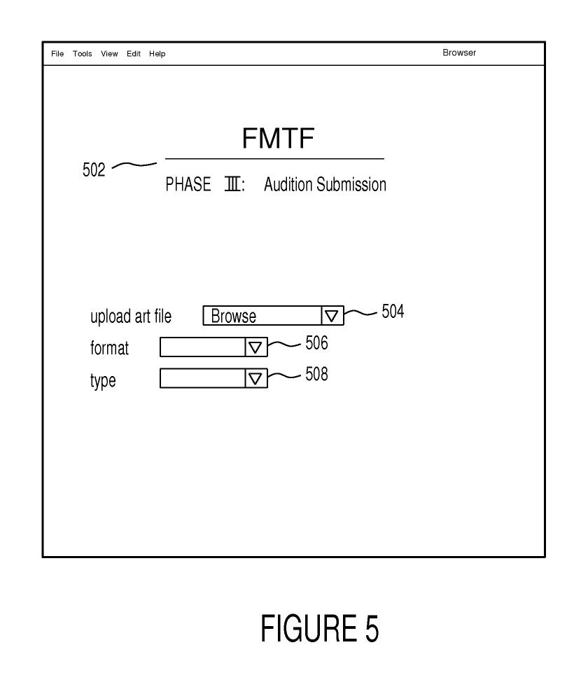

FIG. 5 shows an example artistic audition webpage configured for audition submission. In various embodiments, the audition website includes an audition webpage having title 502, appropriate user interface such as art file upload button 504, file format pick-list 506, and art type pick-list 508.

In various embodiments, after the user has registered and completed his profile, the user may proceed to submit his audition material in phase III of the process. For example, the user may upload a music file created by the user of his own musical performance via the file upload button 504. The user may further select a format for the file, such as MP3 (a common audio file format) or WMP (Windows Media Player format), to allow the audition website server to organize, distribute, play, or otherwise process with appropriate tools and settings. The user may further identify the type of art or genre of music. For example, the user may indicate that the uploaded file is an audio file, a picture file, or a video file.

Those skilled in the art will appreciate that the type of art may be identified by many categories and subcategories, and by many parameters such as musical instrument, period of the art, styles like rock or blues, style of painting like impressionist or classic, style of performance, and the like. In various embodiments, the time length (when played) and/or size of the file may be limited to a predetermined level. For example, a music file may have to be shorter than five minutes when played, or the size of the music file may be limited to 2.5 MB.

Once the user has completed the initial phases of submission of audition material, the audition process may start using the audition website and other participants. In various embodiments, the submission may be posted on the audition website for all registrants or members of the audition site to view, rate/score, comment on, challenge, or otherwise interact with. Prior to being posted, the contents of the submission may be previewed by a site manager or editor to verify conformance with entry requirements. For example, if the play-length of the file is longer than a prescribed amount of time, the submission may be disqualified. Similarly, if the content of the file does not meet a minimum quality requirement or other criteria such as genre for a particular contest, the submission may be disqualified and not posted.

The audition website may include many services, information, and other facilities for the users. for example, a News Column may be provided, calling out the headlines of the week, the trends in voting on the audition website, interesting stories about contestants and site status information. Other facilities may include continuously updated “new entries” video scroll, continuously updated democratic “Polls,” resulting in various statistics such as basic “top 20”—the 20 contestants who have distinguished themselves based on the number of “fans” they have gathered on the audition website, the largest fan bases and the like. Other information may include updated “top 10”—the 10 selected contestants who the audition website's administration team have identified as the “ones to watch”.

In various contests among those who have submitted their audition material, contestants may view and comment on all other contestant auditions, allowing them the option of becoming a “fan”, challenging the contestant to a face-off, such as Five Minute Faceoff (FMF), request an encore, and the like. Contestants may also view and comment on all other postings on the site, including those in the archived video library.

In various embodiments, the contestants may also challenge another to a popular vote through an FMF challenge. Contestants may request an “encore” or repeat performance, and if a contestant garners enough requests for an encore as determined by prescribed number, the contestant may be rewarded with award points redeemable in various ways, such as free subscription or membership upgrades to allow access to further information or contests, exposure to talent scouts, merchandise and/or services discounts, and the like.

In some embodiments, the contestant may edit/update personal profile page with photos and current information. Contestant may also check status of his/her audition submission, see how many fans and views his submission has had, and other similar information. The contestant may start a fan page for himself or another contestant. In some embodiments, a contestant may be able to submit another audition while signed on to the website.

In some embodiments, an internal site search engine may be used to allow contestants to search for auditions and/or contestants based on type, genre, song, name, and the like. In some embodiments, a countdown to election day may be presented to show when the winner of a contest is announced based on contestant reviews, votes, number of fans, and the like.

In various embodiments, targeted audition and performance advice and/or preparation kits featuring experts in the appropriate field of art, such as music or vocal training, or other products and services may be offered to a particular user for purchase using money or award points earned previously. Such targeted services and goods may be offered to the particular user as a result of the particular user's profile and/or performance, winning a contest, having a large number of fans, having submitted a predetermined number high quality entries, and the like.

In some embodiments, weekly and/or monthly winners may be announced, for example, based on prizes/rewards for consistent presence or triumphant presence in the polls, which rewards may also be associated with advertisements and promotions on the audition site. In some embodiments, consultation services may be offered, for example, “Ask the Experts” section, where a trusted industry professional offers specific notes to contestants wishing to submit or resubmit an audition.

In some embodiments, the public may access a contestant by the contestant's public name. Contestants must select a public user name for this purpose, for the protection of the contestant, and to preserve intellectual property of the website or its owner or its manager or any combination of these. The contestant may have a dedicated password and registration number. A registration number may be utilized to search on the site by restricted site users rather than by the general public, for example including friends and family.

The site may contain fillable tabs that are provided for selection and inputs by participants. Some of these may be accessible to all, while others may be concealed or otherwise restricted to certain authorized users.

A tab may be provided for contestant access only which enables contests to check profile status, such as an updated number of fans, number of opinions registered, and to support posting of messages to fans. This latter feature may be restricted to contestants achieving a predetermined threshold of popularity, sukchk as charting in the top one hundred performances. Also, contestants may change profile information.

A tab may be provided to enable a second chance audition.

The tabs may include a page dedicated to rules and regulations, such as posted under a “news” or “notes” section.

News pertaining to performances may be posted on the site, and may be accessed by a dedicated tab.

A tab may offer the options of identifying highly rated contestants, such as the top one hundred.

A tab may identify contestants displaying rising popularity trends.

A tab may enable site goers to list a headline related to a selected contestant. This may be a site area reserved for the public, and approved by the site.

A tab or site area may be dedicated to headlines or other postings from record labels or other restricted parties.

The site may have a tab or area dedicated to posting of advice to specified contestants, comments being provided by designated experts. Tabs may be provided for specific topics relating to advice. For example, a tab may display a judgment of poor, good, and excellent as to breathing. Another tab may post suggestions, such as to slow or accelerate breathing, take deeper breaths, and the like. A further tab may announce judgments relating to pitch, such as low, high, uneven, perfect, and the like. A further tab may post suggestions regarding image and presentation, charisma, wardrobe choices, general suggestions regarding appearance, and specific steps to improve professional marketability by a contestant. These actions by judges, experts, and the like may be accessible to site goers by selectable tabs. Access may be permitted or denied at the discretion of label and site management.

A tab or area of the site may enable voting for contestants by fans, who may also be able to post views, and may include display of voting totals. Judging totals may similarly be posted for access by selectable tab. Judging totals may be limited to a selected number of contestants, such as the ten most favorably assessed (“top ten”).

A contestant may be placed in an arbitrary category such as “judges' top ten” for a predetermined time period such as one month. When the time period has expired, the contestant may be relegated to another area. Professionally highly regarded contestants may be classified by a suitably named category such as “platinum mic (microphone) club” for example. Such a category may display history of top ten charts, arrival date, length of stay, chart position, and progression of contestants. Attainment of the highly regarded category may entitle contestants to rewards or issuance of premiums.

The site may have a tab or area displaying judging opinions of a contestant or a specific performance. Opinions may include standardized ratings, such as poor, fair, and good, among others.

Judge selected top ten and site goer voted top ten may each be accessible to site goers.

A tab may enable contestants and site goers to view contest fan levels, as determined by voting, count of new fans who have voted since a predetermined date, total numbers of fans, votes, and contestants deemed to be noteworthy in their ascendance (“judge's one-to-watch”).

A tab may show contestants moving into a top echelon by voting, such as the top one hundred contestants.

The site may have a tab accommodating a challenge by one contest to another. In an exemplary challenge, a first contestant to sing a particular song may be challenged by another contestant wishing to improve on the former's performance. Should the former accept the challenge, the site may then host a contest between the two. Site goers may be afforded the choice of specific compositions or artist/song genre for this contest. The participating contestants may agree to sing one or more selections of each of the two. The ensuing performances may be rated by site goers, with the results posted. The site may select among such challenge contests for broadcasting thereof on the site.

A tab may display a running time counter such as a ticker style clock that announces time remaining until a contest deadline and the judge(s)' decision.

It is anticipated that a considerable revenue stream may be generated given the options to vote or become a “fan”, to receive premiums, to view biographic and other information regarding contestants, to vote for selections such as favorite songs, to post blogs. These options may be subject to contestant and site discretion.

A ballot enabling site goers to vote may be presented as a scrollable display showing contestant auditions, views, and vote totals. Plural votes by any one site goer may be accepted, but may be subject to a limitation such as one vote per genre per day, two total votes per day, and others.

The site may require that site goers register as fans to access certain posted content, such as a profile page. Once registered, a site goer having fan status may be entitled to less restricted content offerings, and may become eligible for promotional give-away items and other benefits.

A profile page may display contestant-provided information such as preferred nickname, favorite quote, mission or philosophy statement, favorite performers, and significant professional influences. The profile page may display the number of fans for a contestant.

A profile page may display the number of challenges issued by or issued against the contestant, pending challenges, and challenge results.

A tab of the profile page may display charting by the day, month, or year.

A tab may show contestant rate, progression, and highest rate.

A tab may show the contestant's status as a headliner.

A site page may be dedicated to enable site goers and fans to view contestant fan levels. Each contestant may be placed in a category indicating level of fan support. These categories may be provided with interesting names. Illustratively, a contestant having at least 500 views from the public or up to 200 fans may have a publicity categorization of a “Backyard BBQ”; 500-1,000 views or 200-500 fans may have publicity categorization as “Local Bar or Restaurant”; 1,000-1,500 views or 500-1000 fans may have publicity categorization as “Town Hall”; 5,000-10,000 views or 2,500-5,000 fans may have publicity categorization as “Arena”; and 15,000-20,000 views or more than 10,000 fans may have publicity categorization as “Stadium”. A contestant having one of the hundred highest fan vote totals may have publicity categorization as “Charted”. Furthermore, highly viewed contestants may be designated “platinum mic status”, which could comprise chart movers and contestants labeled by judges as “ones to watch”.

Contestants attaining “Platinum mic” status may be awarded premiums or promotional give-away items. These may also be given to random voters, challenge winners, and fans making a judge's top ten list or a fans' top ten list.

One or more record labels may have a dedicated site page. This page may post news from the label, may include information on decision matters for contest winners within each performance or musical category, news regarding artists, news pertaining to artist sponsorships and endorsements, impending concerts and album releases, the label's top ten performances or artists, the fan's favorite top ten performances or artists of that label, as determined by votes or number of views or “hits”, and “top ten to watch”, as designated by the label, which may be limited to platinum mic achievers.

The record label page may show encores requested by judges, and platinum mic achievement notifications. The latter may permit contestants to submit a second audition free of charge. This offering may be monthly for example. Encore status may be limited to attainment of a predetermined status, such as that of chart mover.

Fan requests may also appear on the record label page, with that contesting receiving the most votes being awarded a free audition and optionally platinum mic status.

The following provides examples of the aforementioned disclosure:

### Examples

### I. Site Function

a. TAB FUNCTION
i. User Name: Public is able to access contestants by user name.
   NOTE: contestants must use and choose public user name (for contestant's protection and site's intellectual property).
1—A user name log in: real name access to profile page.
2—Password:
   a. selected by contestant
   b. contestants registration number
3—Search: by contestant ID No, which allows contestants to allow screening of submissions if not available to public (contestants choice) i.e. friends+family, by sharing password+guest registration.
4—Check+change profile (contestants only): this tab allows contestants to check profile status. i.e. new fans and # of views as well as post on charts toppers blog, and post messages to fans, this feature is only available to contestants, that have charted in the top -100- contestant can change basic profile information, provided at registration, *registration and password required for this feature*
5—This tab allows existing contestants to register for 2^{nd} chance audition.
6—Rule+regulations page *leave for legal department* tab headings under News/Notes.
7—Allows public+contestants to view site news.
   7a. contestants making headlines listed top -100- (label+public) contestants to watch.
   7b. this tabs allows the public to list a headline regarding their favorite contestant.*fans only*(site approved)
   7c. this tab allows public+contestants to see who's making headlines “on the rise”
   7d. record label only headlines*.
8—Ask the experts will provide advice in this section, about contestants at the *choosing of the label*.
   8a. judges opinion of overall performance (platinum mics). Note: platinum mics #ed 1-5.
   8b. any feedback available to auditions, song choice, and poor- fair- good. judges suggestions.
   8c. Technical Advice
      NOTE: D- E- F is subheadings in this category.
   8d. breathing: poor- good- excellent.
   8e. correction if necessary. i.e.: slow down- speed up- deeper breaths- etc.
   8f. pitch: low- high- uneven- perfect.
   8g. judges suggestions about image and presentation, i.e. what a contestant can do to improve market ability, as well as tips on charisma and possible wardrobe choices, and overall general suggestions to improve contestants' aesthetics.
   Voting top ten dictated by the fans—views and votes. A contestant can only stay in judges top ten for 1 month, then they are relegated to the Platinum Mic Club, (Note: this tab lists history of top ten charts, date of arrivals, length of stay, chart position, and progression of contestants.
   Platinum Mic Club members are eligible for free swag.
   8h. this tab allows the public to see the experts' advice regarding contestants and 2^{nd} chance audition. (This will be provided at the discretion of label and site management).
9—Data—top ten lists: this tab allows public and contestants view judge's top ten, top ten vote's getters.
10—Chart mover—by catalog votes: this tab allows contestants and public to see any given contestants fan levels (see fan page), new fan totals, # of votes, overall # of fans, judges one to watch selection.
11—Chart buzz: this tab shows recent votes results, and any artist that are moving into the top 100 contestants in the contest, according to public votes.
   11a. head to head challenges: when an existing contestant feels that they can do a better job of another contestant's song, they can challenge them, if that contestant agrees then the public votes on which song they will sing.
   NOTE: the site will provide presented choices based on artist genre, Rock Group category—R&B, Country, or contestants may agree to song swap in which they sing each other's audition tape song, and then this may be submitted to a public forum to be voted on by the general public. *The site will decide which challenges will air on site.*
12—This tab is the running ticker style clock that tracks time until the contest deadline and (labels) judge's decision.
13—Huge revenue stream: public register to vote or become a fan (fans can access lots of free swag giveaways, contestants bio info—general info i.e. favorite songs, sign+contestant posted blog, at contestant discretion and site's approval).
14—Official Ballot: Democra-sing: cursor to scroll though contestant auditions, views, and vote.
15—Ballot Box: public can vote as many times as they wish, but only 1 vote per genre per day. *Contestants can vote twice a day.
16—NOTE: The public may vote on and view contestant submissions any time, but must become a fan to view profile page, once a fan has registered they may view unlimited contestant profiles as well as other site bonuses and info. only registered fans will be eligible for free swag excluding occasional promo giveaways.

### Profile Page

Contestants only+Fans
   1. This tab allow contestant to select a nickname.
   2. Contestant's favorite quote and mission statement (limited characters) in their own words (site approved).
   3. Contestants enter favorite musicians and influences.
   4. # of fans/who artist identifies with as an artist.
   5. Challenge status: this tab shows in a contestant has any challenges
      a. # of challenges
      b. Pending challenges
      c. Challenge outcome
   6. This tab shows if the contestant is charted the month, day and year.
   7. This tab shows contestants rate, progression, and highest rate.
   8. This show the contestants headliner status see tab 7a to 7d or explanation. News/Notes tab.

### Fans Levels

This page allows the general public+fans to view contestants fan levels (however only fans vote to effect fan level results).

### Rates Contestants

### Fans Level Ratings

1. Backyard BBQ: 500 public views or 1→200 fans.
2. Local Bar/restaurant: public views 500→1000 or 200→500 fans.
3. Town Hall: public views 1000→1500 or 500→1000 fans.
4. Charted: top 100 in fan vote totals.
5. Arenas: public views 5000→10,000 or 2500→5000 fans.
6. Stadium: public views 15,000→20,000, Platinum Mic Club fans 10,000+ up.
   NOTE: Label and site managers may assign Arena or Stadium fan level to any contestant by assigning them *Platinum mic status*. This category should primarily consist of chart movers and label “ones to watch” selections.

### Swag List

Swag awarded to platinum mic holders.
Random fan voter giveaways.
Challenge winner give away.
Fans that make judges top 10 or fans top 10 lists.

### Record Label

1. News: posted by label.
2. Panel: info on final decision maters for contest winners in each category.
3. Online suggestions judges' bio and info. Artists that the judges are currently associated with.
4. Artists News: site posted.
5. Artist sponsorships endorsements career news and upcoming concerts and album releases (Note: available only after first contest cycle).
6. Top ten: labels favorite top 10, fans favorite top 10, by votes+views.
7. Labels top ten to watch, platinum mic contestants only. Top ten contestant based on fan votes and views.
8. Judges request encore, judges send contestant platinum mic notification allowing them to submit 2^{nd} audition free of charge posted monthly.
9. Fans request encore: every month the contestant with the most votes will receive a free audition, and platinum mic status.
   NOTE: A contestant can only be eligible for encore vote when chart mover status has been achieved.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. An audition website comprising:
a registration webpage configured to register a user and create a user account for a predetermined number of audition submissions; and
a submission webpage configured to allow the user to upload an audition submission for review by participants on the audition website.

2. The audition website of claim 1, further comprising a profile building webpage.

3. The audition website of claim 2, wherein the profile building page comprises a user interface to allow entry of information about the user, which information is usable to offer tailored services to the user.

4. The audition website of claim 3, wherein the information about the user includes favorite artists, art genre, and favorite pass-time.

5. The audition website of claim 1, further comprising information about submissions from all website users.

6. The audition website of claim 5, wherein the information about submissions include top-20 contestants, top-10 auditionees, and a contestant with a largest fan club.

7. The audition website of claim 1, wherein the registration webpage is configured to register the user based on a unique Identification (ID) number obtained by the user prior to registration.

8. The audition website of claim 1, wherein the submission webpage includes user interface for uploading a submission file, a file format field, and a submission type field.

9. The audition website of claim 1, wherein the audition website is configured to organize an overall audition process into multiple phases.

10. The audition website of claim 9, wherein each of the multiple phases has an associated time period during which activities in the corresponding phase are completed.

11. The audition website of claim 10, wherein the time period is predetermined.

12. The audition website of claim 10, wherein the time period is dynamically determined based on entered user profile.

13. The audition website of claim 1, wherein user is awarded award points for performance and wherein the award points are usable to purchase goods, services, and account upgrades.

14. The audition website of claim 1, wherein the audition website provides targeted advertisement and service offerings to the user based on the user's profile and performance.

15. A method of auditioning contestants, the method comprising:
presenting a registration webpage configured to register a user and create a user account for a predetermined number of audition submissions; and
presenting a submission webpage configured to allow the user to upload an audition submission for review by participants on the audition website.

16. The method of claim 15, further comprising presenting a profile building webpage configured to allow user profile information entry, wherein the information is usable to provide targeted goods and services to the user.

17. The method of claim 15, wherein the registration webpage is configured to register the user based on a unique Identification (ID) number obtained by the user prior to registration.

18. The method of claim 15, wherein the registration webpage and the submission webpage are parts of an audition website and are organized as corresponding timed phases.

19. The method of claim 18, wherein the audition submission is presented for review by other users of the audition website.

20. The method of claim 18, wherein the user is awarded point by the audition website based on the performance of the user's submission.
